(19) United States
(12) Patent Application Publication
(10) Pub. No.: US 2005/0180711 A1
(43) Pub. Date: Aug. 18, 2005

(54) Dual loop automatic power control of optical transmitters

(76) Inventors: Kishore K. Kamath, Allentown, PA (US); Ihab E. Khalouf, Allentown, PA (US); Sunil Priyadarshi, Macungie, PA (US)

Correspondence Address: DUANE MORRIS, LLP;IP DEPARTMENT, ONE LIBERTY PLACE, PHILADELPHIA, PA, 19103-7396, US

(21) Appl. No.: 10/779,340

(22) Filed: Feb. 13, 2004

(51) Int. Cl. H04B 10/12

(52) U.S. Cl. 385/129

(57) ABSTRACT

Output optical power of an optical transmitter is regulated to compensate for fluctuations in output optical power and for tracking error. Dual loop automatic power control includes an optical sensor feedback loop for sensing optical energy proximate a back facet of the optical transmitter and a thermal sensor feedback loop for sensing thermal energy at point proximate the optical transmitter. Fluctuations in sensed thermal energy are indicative of the tracking error of the optical transmitter. Signals indicative of the sensed optical and thermal energy are combined and utilized to regulate the output optical power to be approximately constant over a predetermined range of temperatures.

### FIELD OF THE INVENTION

The present invention is generally related to optoelectronics and more specifically related to automatic power control of optical transmitters.

### BACKGROUND

Typical laser transmitter systems utilize an automatic power control (APC) loop to control the power coupled into an optical fiber therein. Typically, the APC loop attempts to maintain constant photocurrent by monitoring optical energy at the back facet of the transmitter via a back-face monitor photo diode. However, adjusting photocurrent in response to monitored optical energy at the back facet only, does not compensate for the tracking error of the transmitter.

Tracking error is a parameter commonly used to describe optical transmitters. Tracking error is indicative of the change in coupled power which occurs during a change in temperature, at constant back-face monitor current. Tracking error includes variations in the output optical power due to changes in the ratio of optical power between the back facet (point where monitor signal is generated) and the front facet (point where the output optical signal is provided) of the optical transmitter (such as a laser), and due to changes in coupling (coupling efficiency). For a more detailed description of tacking error, see Fiber-Optic Communications Technology, Written by Djafar K. Mynbaev, Lowell L. Scheiner. Chapter 9 “Light Sources and Transmitters” Page 354, Prentice Hall, ISBN 0-13-962069-9, for example, which is hereby incorporated by reference in its entirety as if presented herein.

A power control apparatus and method for regulating the output optical power of an optical transmitter, which compensates for tracking error is desired.

### SUMMARY

In a first embodiment, a method for regulating power of an output optical signal of an optical transmitter includes sensing optical energy proximate a back facet of the optical transmitter and sensing thermal energy proximate the optical transmitter. The sensed thermal energy is indicative of a tracking error of the optical transmitter. The method also includes regulating the power of the output optical signal in response to the sensed thermal energy and the sensed optical energy.

In another embodiment, an apparatus for regulating power of an output optical signal of an optical transmitter includes an optical sensing portion for sensing optical energy at a back facet of the optical transmitter, a thermal sensing portion for sensing thermal energy proximate the optical transmitter, and a power control portion for adjusting the power of the output optical signal responsive to the sensed optical energy and the sensed thermal energy. Temperature values of the sensed thermal energy are indicative of a tracking error of the optical transmitter.

### BRIEF DESCRIPTION OF THE DRAWINGS

In the drawings:

FIG. 1 a functional block diagram of an apparatus for dual loop automatic power control of an optical transmitter in accordance with an embodiment of the present invention;

FIG. 2 a schematic diagram of an apparatus for dual loop automatic power control of an optical transmitter in accordance with an embodiment of the present invention; and

FIG. 3 a flow diagram of a process for regulating output optical power of an optical transmitter in accordance with an embodiment of the present invention.

### DETAILED DESCRIPTION

Dual loop automatic power control of an optical transmitter in accordance with an embodiment of the present invention includes an optical sensor feedback loop comprising an optical sensor and a thermal sensor feedback loop comprising a thermal sensor. The optical sensor senses optical energy proximate a back facet of the optical transmitter. This sensed optical energy is converted to an electrical signal, which is fed back to the optical transmitter, to adjust the power of an output optical signal provided by the optical transmitter. The thermal sensor senses thermal energy at point proximate the optical transmitter. This sensed thermal energy is converted into an electrical signal and combined with the electrical signal indicative of the sensed optical energy. The combined electrical signal (indicative of both sensed optical and sensed thermal energy) is utilized to regulate the output optical power to be approximately constant over a predetermined range of temperatures. Thermal sensing and feedback in this manner overcomes a disadvantage of adjusting output optical power responsive only to optical energy proximate the back facet of the optical transmitter. Optical sensing at the back facet, alone, does not compensate for optical transmitter tracking error.

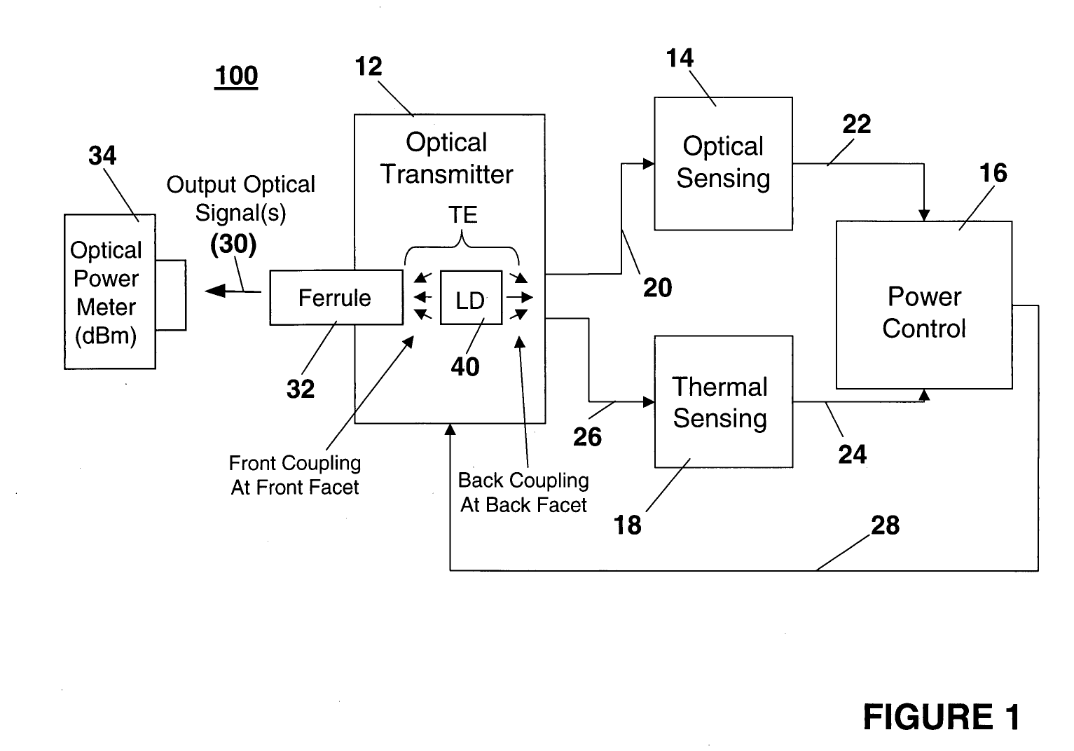

Referring now to FIG. 1, there is shown a functional block diagram of an apparatus 100 for regulating the power of an output optical signal 30 of an optical transmitter 12 in accordance with an embodiment of the present invention. The apparatus 100 comprises the optical transmitter 12, an optical sensing portion 14, a thermal sensing portion 18, and a power control portion 16. The optical transmitter 12 may be any appropriate optical transmitter, such as a laser transmitter for example. In one embodiment of the apparatus 100, the optical transmitter 12 is not cooled (uncooled). Accordingly, temperature variations within the optical transmitter 12 will affect the power of the output optical signal 30. In an exemplary embodiment of the apparatus 100, the optical transmitter 12 comprises a laser diode 40 for emission of optical energy. A portion of the emitted optical energy is coupled to the ferrule 32 via optical coupling at a front facet of the optical transmitter 12. The ferrule 32 may comprise any appropriate means for coupling optical energy from the laser diode 40 to obtain the output optical signal 30. Ferrules are known in the art. Typically a ferrule constrains (e.g., adhesively) an optically conductive medium, such as an optical fiber or a waveguide, and aligns optical energy with the optically conductive medium. Ferrules may comprise materials such as plastic, ceramic, and stainless steel, for example. Ferrules may also be incorporated into a variety of types of connectors.

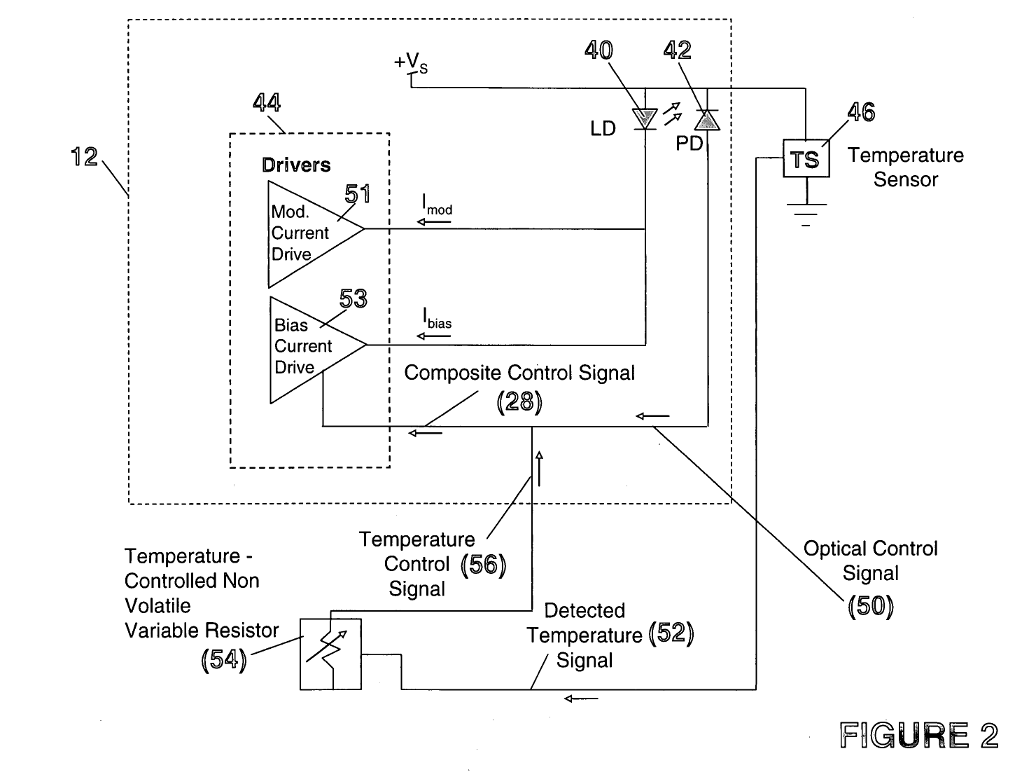

The optical sensing portion 14 may include any appropriate optical sensor, such as a photo diode (see FIG. 2), for example. The optical sensing portion 14 senses optical energy at the back facet of the optical transmitters 12. The optical transmitter 12 provides a back coupled optical signal 20, which is indicative of optical energy at the back facet of the optical transmitter 12. As the optical energy provided by the laser diode 40 varies, the back facet optical energy varies, and the optical energy sensed by optical sensing portion 14 accordingly varies. The optical sensing portion 14, senses the optical energy at the back facet of the optical transmitter 12 and provides an optical control signal 22 indicative of the sensed (detected) optical energy at the back facet of the optical transmitter 12. The optical control signal 22 may be in any appropriate form, such as optical, electrical, electromagnetic, or a combination thereof. The optical control signal 22 is provided to the power control portion 16. Power control portion 16 receives the optical control signal 22 and provides composite control signal 28 for regulating the power of the output optical signal 30 of the optical transmitter 12. In one embodiment, the power control portion 16 adjusts the power of the output optical signal 30 to be approximately constant. Thus, as optical energy at the back facet of the optical transmitter increases (e.g., intensity, power, flux density), the power control portion 16, provides the composite control signal 28 for reducing the optical energy provided by the laser diode 40, such that the power of the output optical signal 30 remains approximately constant. As optical energy at the back facet of the optical transmitter decreases (e.g., intensity, power, flux density), the power control portion 16, provides the composite control signal 28 for increasing the optical energy provided by the laser diode 40, such that the power of the output optical signal 30 remains approximately constant. Power of the output optical signal 30 may be detected and/or measured by any appropriate means, such as optical power meter 34, for example.

Adjusting the power of the output optical signal 30 responsive to only optical energy at the back facet of the optical transmitter 12 does not compensate for any fluctuations in the power of the output optical signal 30 as a result of tracking error (change in front to back power ratio of the transmitter and/or change in coupling efficiency due to temperature fluctuations) of the optical transmitter. Sensing thermal energy within the optical transmitter 12, such as by the thermal sensing portion 18, and adjusting the power of the output optical signal 30 accordingly, helps alleviate this problem. The optical transmitter 12 provides a thermal energy signal 26, which is indicative of thermal energy developed within the optical transmitter 12. The thermal sensing portion 18 senses thermal energy within the optical transmitter 12. The thermal sensing portion 18 may include any appropriate thermal sensor, such as a temperature sensor, a thermistor, or a combination thereof, for example. However, thermistors tend to have a nonlinear transfer function, and in one embodiment of the apparatus 100, a more linear device such as a temperature sensor (see FIG. 2) is considered to be more advantageous. Thermal energy may be sensed at any appropriate location (point) within the optical transmitter 12. Typically, the physical coupling of the laser diode 40 and the ferrule 32 is shielded to facilitate as much optical energy as possible being coupled between the laser diode 40 and the ferrule 32. Thus, it is not practicable to sense thermal energy within this shielded coupling. It is advantageous, however, to sense optical energy proximate the front facet of the optical transmitter between the laser diode 40 and the ferrule 32. As the thermal energy developed within the optical transmitter 12 varies, the thermal energy sensed by thermal sensing portion 18 accordingly varies. The thermal sensing portion 18, senses the thermal energy within the optical transmitter 12 and provides a thermal control signal 24 indicative of the sensed (detected) thermal energy within the optical transmitter 12. The thermal control signal 24 may be in any appropriate form, such as optical, electrical, electromagnetic, or a combination thereof. The thermal control signal 24 is provided to the power control portion 16. Power control portion 16 receives the thermal control signal 24 and provides composite control signal 28 for regulating the power of the output optical signal 30 of the optical transmitter 12. In one embodiment, the power control portion 16 adjusts the power of the output optical signal 30 to be approximately constant. Thus, as a variation of the thermal energy within the optical transmitter (e.g., intensity, power, flux density) causes the power of the output optical signal 30 to increase, the power control portion 16, provides the composite control signal 28 for reducing the optical energy provided by the laser diode 40, such that the power of the output optical signal 30 remains approximately constant. As a variation of the thermal energy within the optical transmitter (e.g., intensity, power, flux density) causes the power of the output optical signal 30 to decrease, the power control portion 16, provides the composite control signal 28 for increasing the optical energy provided by the laser diode 40, such that the power of the output optical signal 30 remains approximately constant. The sensed optical energy as indicated by the optical control signal 22 and the sensed thermal energy as indicated by the thermal control signal 24 are combined by the power control portion 16. The power control portion 16 provides the composite control signal 28, which is indicative of the combined optical control signal 22 and the thermal control signal 24, to the optical transmitter 12 to regulate the power of the output optical signal 30.

Referring now to FIG. 2, there is shown a schematic diagram of an apparatus for regulating power of an output optical signal of an optical transmitter 12, in accordance with the present invention. The optical transmitter 38 comprises a laser diode 40, a photo diode 42, and driver portion 44. The driver portion 44 comprises current amplifiers (drivers) 51 and 53, for amplifying modulation current, I_{mod}, and bias current, I_{bias}, respectively, of the laser diode 40. Providing modulation current and bias current to laser diodes is know in the art. Typically, an optical signal to be transmitted by a laser diode is generated by modulating a bias current (e.g., I_{bias}) with a modulation current (e.g., I_{mod}). For example, see Optical Fiber Communications, by Gerd Keiser. 2^{nd} edition. Chapter 4 “Optical Sources” Pages 131-195. From McGraw-Hill. Inc. ISBN 0-07-033617-2, for a description of laser diode operation, which is hereby incorporated by reference in its entirety, as present herein. The circuit shown in FIG. 2 also comprises a temperature sensor 46 and a temperature controlled variable resistor (TCVR) 54. In one embodiment, the TCVR is non volatile, such that values stored in the TCVR are not lost when power is removed from the TCVR.

In operation, a portion of the optical energy transmitted by laser diode 40, is sensed (detected) by photo diode 42 (e.g., at the back facet of the optical transmitter 12). The photo diode 42 converts sensed (detected) optical energy into an electrical photo diode (PD) control signal 50, which is indicative of the sensed optical energy. The PD control signal 50 is functionally analogous to the optical control signal 22 described above with respect to FIG. 1. The PD control signal 50 is utilized to control the bias current amplifier 53, which in turn adjusts the optical energy (e.g., intensity, power, flux density) transmitted by the laser diode 40, via the bias current, I_{bias}, to regulate the power of the output optical signal of the optical transmitter 12 to be approximately constant.

The temperature sensor 46, which may comprise any appropriate temperature sensor as described above, senses thermal energy proximate the optical transmitter 12, and converts the sensed (detected) thermal energy into an electrical detected temperature signal 52, which is indicative of the sensed thermal energy. The detected temperature signal 52 is provided to the TCVR 54. The TCVR 54 receives the detected temperature signal 52 and provides the temperature control signal 56. The temperature control signal 56 is functionally analogous to the thermal control signal 24 described above with respect to FIG. 1. The temperature control signal 56 is combined with the PD control signal 50 to form the composite control signal 28. The composite control signal 28, which is indicative of both the PD control signal 50 and the temperature control signal 56, is provided to the bias current amplifier 53, which in turn adjusts the optical energy (e.g., intensity, power, flux density) transmitted by the laser diode 40, via the bias current, I_{bias}, to regulate the power of the output optical signal of the optical transmitter 12 to be approximately constant. As shown in FIG. 2, the PD control signal 50 and the temperature control signal 56 are combined within the optical transmitter 12. This depiction is exemplary. In other embodiments, the PD control signal 50 and the temperature control signal 56 may be combined outside of the optical transmitter 12.

The temperature controlled variable resistor (TCVR) 54 comprises a plurality of resistance values. Each resistance value corresponds to a detected temperature value, or range of detected temperature values, as provided by the temperature sensor 46 via detected temperature signal 52. Thus, for each detected temperature value received by the TCVR 54 via the detected temperature signal 52, a corresponding resistance value is selected and utilized to provide the temperature control signal 56, which is indicative of the selected resistance value. Various embodiments of the temperature sensor 46 and the TCVR 54 are envisioned. For example, in one embodiment, the temperature sensor 46 may comprise an analog to digital converter (ADC) for providing the detected temperature signal 52 in a digital format. This digital detected temperature signal 52 is decoded by the TCVR 54 and used to select a TCVR resistance value. In another embodiment, the TCVR 54 comprises the ADC. In yet other embodiments, either the temperature sensor 46 and/or the TCVR 54 comprises a quantizer for quantizing the detected temperature values, which are mapped to respective resistance TCVR values.

In one embodiment, the plurality of resistance values of the TCVR 54 is determined heuristically. That is, the power of the output optical signal 30 is measured, by optical power meter 34 for example, for specific detected temperature values, as detected/sensed by the temperature sensor 46, over a predetermined range of temperature values. The resistance value of the TCVR 54 is then adjusted until the power of the output optical signal 30 is equal to a predetermined (desired) value. This value of TCVR resistance is mapped into the TCVR 54 for the specific detected temperature value.

In another embodiment, the plurality of resistance values of the TCVR 54 is determined heuristically and analytically. In this embodiment, a portion of the plurality of TCVR resistance values is heuristically determined as described above. The remainder of the plurality of TCVR resistance values is analytically determined by interpolating between the heuristically determined values of TCVR resistance values. Any appropriate interpolation means may be used, such as by utilizing a polynomial fit for example.

In one exemplary embodiment, values of TCVR resistance are determined for the temperature values of −40° C., 25° C., and 85° C., respectively. Each of these three TCVR resistance values is determined to provide an output optical signal power of 0-dBm at each respective temperature. Values of TCVR resistance for temperatures between the range of −40° C. to 85° C. are calculated by using a polynomial fit to interpolate the TCVR resistance values obtained for −40° C., 25° C., and 85° C., respectively.

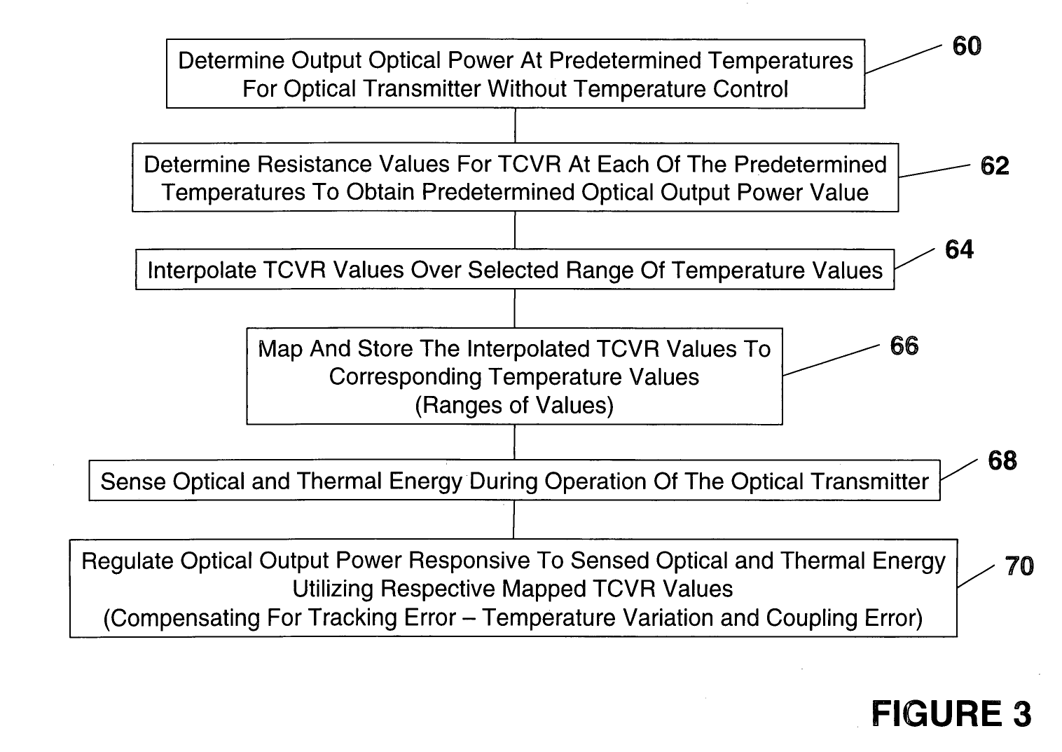

FIG. 3 is a flow diagram of a process for regulating the power of an output optical signal 30 for an optical transmitter 12 in accordance with an embodiment of the present invention. The process depicted in FIG. 3 includes steps to determine the TCVR resistance values and steps to regulate the power of an output optical signal 30 utilizing sensed optical and thermal energy as described above. At step 60, the power of the output optical signal 30 is determined (such as measured by optical power meter 34) for predetermined temperature values (e.g., −40° C., 25° C., and 85° C.) as sensed by the temperature sensor 46. No temperature control is used to regulate the power of the output optical signal 30 during step 60. At step 62, TCVR resistance values are determined for each of the respective predetermined temperature values, to obtain a predetermined value of power of the output optical signal 30. The TCVR resistance values determined at step 62 are interpolated at step 64 over a selected range of temperature values. The interpolation may be accomplished to achieve any desired resolution (e.g., temperature step size of 2° C.) within constraints (e.g., memory). At step 66, the interpolated values of TCVR resistance are mapped into the TCVR 54 corresponding to respective temperature values (e.g., provided by the detected temperature signal 52). It is envisioned that each TCVR resistance value will by mapped to a range of temperature values corresponding to the resolution of the detected temperatures. Thus, if the resolution of the detected temperatures if 2° C., each TCVR resistance value will be mapped to a range of temperatures of approximately 2° C. The TCVR resistance values are then stored in the TCVR 54. During operation, at step 68, optical and thermal energy is sensed and utilized, as described above, to regulate the power of the output optical signal to be approximately constant over a predetermined range of temperatures.

The dual loop power control for regulating output optical power of an optical transmitter in accordance with the present invention may be embodied in the form of computer-implemented processes and apparatus for practicing those processes, wherein power control portion 16 (see FIG. 1) is a computer processor and the computer-implemented processes are as described herein. The dual loop power control for regulating output optical power of an optical transmitter in accordance with the present invention may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by computer processor 16, the computer processor 16 becomes an apparatus for practicing the invention. The dual loop power control for regulating output optical power of an optical transmitter in accordance with the present invention may also be embodied in the form of computer program code, for example, whether stored in a storage medium, loaded into and/or executed by computer processor 16, or transmitted over some transmission medium, such as over electrical wiring or cabling, through fiber optics, or via electromagnetic radiation, wherein, when the computer program code is loaded into and executed by computer processor 16, the computer processor 16 becomes an apparatus for practicing the invention. When implemented on a general-purpose processor, the computer program code segments configure the processor to create specific logic circuits.

Although dual loop power control for regulating output optical power of an optical transmitter, in accordance with the present invention has been described in conjunction with one or more preferred embodiments, it will be apparent to those skilled in the art that other alternatives, variations and modifications will be apparent in light of the foregoing description as being within the spirit and scope of the invention. Thus, dual loop power control for regulating output optical power of an optical transmitter, in accordance with the present invention is intended to embrace all such alternatives, variations and modifications as may fall within the spirit and scope of the following claims.

1. A method for regulating power of an output optical signal of an optical transmitter, said method comprising the steps of:
sensing optical energy proximate a back facet of said optical transmitter;
sensing thermal energy proximate said optical transmitter, wherein:
sensed thermal energy is indicative of a tracking error of said optical transmitter; and
said tracking error is indicative of a temperature difference between said back facet and a front facet of said optical transmitter and a change in coupling efficiency within said optical transmitter; and
regulating said power of said output optical signal in response to said sensed thermal energy and said sensed optical energy.

2. A method in accordance with claim 1, wherein said power of said output optical signal is regulated to be approximately constant for a predetermined range of temperature values of said sensed thermal energy.

3. A method in accordance with claim 1, wherein said optical transmitter is an uncooled optical transmitter.

4. A method in accordance with claim 1, further comprising:
providing a detected temperature signal indicative of temperature values of said sensed thermal energy to a temperature controlled variable resistor (TCVR), wherein:
resistance values of said TCVR correspond to respective temperature values of said sensed thermal energy; and
providing a temperature control signal indicative of a selected TCVR resistance value corresponding to a current temperature value of said sensed thermal energy for regulating said power of said output optical signal.

5. A method in accordance with claim 4, wherein said TCVR comprises:
a plurality of TCVR resistance values, each TCVR resistance value corresponding to a respective range of sensed temperature values.

6. A method in accordance with claim 4, further comprising:
determining values of said power of said output optical signal of said optical transmitter at predetermined temperature values;
determining a respective temperature control resistance value for each predetermined temperature value to obtain a predetermined value of power of said output optical signal;
interpolating said temperature control resistance values over a selected range of temperature values for obtaining said plurality of TCVR resistance values; and
mapping each of said plurality of TCVR resistance values to a respective range of sensed temperature values.

7. A method in accordance with claim 6, wherein said predetermined temperature values comprise −40° C., 25° C., and 85° C.

8. An apparatus for regulating power of an output optical signal of an optical transmitter, said apparatus comprising:
an optical sensing portion for sensing optical energy at a back facet of said optical transmitter;
a thermal sensing portion for sensing thermal energy proximate said optical transmitter; and
a power control portion for adjusting said power of said output optical signal responsive to said sensed optical energy and said sensed thermal energy, wherein:
a temperature value of said sensed thermal energy is indicative of a tracking error of said optical transmitter.

9. An apparatus in accordance with claim 8, wherein said tracking error is indicative of:
a temperature difference between said back facet of said optical transmitter and a front facet of said optical transmitter; and
a change in coupling efficiency within said optical transmitter.

10. An apparatus in accordance with claim 8, wherein said optical transmitter is an uncooled optical transmitter.

11. An apparatus in accordance with claim 8, wherein said power of said output optical signal is regulated to be approximately constant for sensed temperature values within a predetermined range of temperature values of said sensed thermal energy.

12. An apparatus in accordance with claim 8, further comprising a temperature controlled variable resistor (TCVR) for receiving a temperature control signal indicative of temperature values of said sensed thermal energy, wherein:
said TCVR comprises a plurality of TCVR resistance values, each TCVR resistance value corresponding to a respective range of sensed temperature values.

13. A circuit for regulating power of an output optical signal of an optical transmitter, said circuit comprising:
said optical transmitter optically coupled to a photo diode;
said photo diode electrically coupled to said optical transmitter and electrically coupled to a temperature controlled variable resistor (TCVR);
a temperature sensor thermally coupled to said optical transmitter; and
said TCVR electrically coupled to said temperature sensor, wherein:
said output optical power is regulated to be approximately constant for a predetermined range of temperature values compensating for coupling efficiencies and temperature differences within said optical transmitter.

14. A circuit for regulating power of an output optical signal of an optical transmitter, said circuit comprising:
an optical transmitter configured to:
receive a composite control signal for regulating said output optical power;
provide an output optical signal having an output optical power value; and
provide back coupled optical energy,
a photo diode configured to:
detect a portion of said back coupled optical energy; and
and provide a photo diode control signal indicative of detected back coupled optical energy;
a temperature sensor configured to:
sense thermal energy proximate said optical transmitter; and
provide a detected temperature signal indicative of sensed thermal energy;
a temperature controlled variable resistor (TCVR) configured:
receive said detected temperature signal; and
provide a temperature control signal, wherein:
said composite control signal is indicative of a combination of said temperature control signal and said photo diode control signal.

15. A circuit in accordance with claim 14, wherein said power of said output optical signal is regulated to be approximately constant for a predetermined range of temperature values compensating for coupling efficiencies and temperature differences within said optical transmitter.

16. A circuit in accordance with claim 14, wherein said optical transmitter is an uncooled optical transmitter.

17. A circuit in accordance with claim 16, wherein said TCVR comprises a plurality of TCVR resistance values, each TCVR resistance value corresponding to a respective range of detected temperature values of said sensed thermal energy.

18. A circuit in accordance with claim 17, wherein said TCVR resistance values are interpolated from a set of pre-interpolated TCVR resistance values determined to obtain a predetermined value of optical output power.

19. A computer readable medium encoded with a computer program code for directing a processor to regulate power of an output optical signal of an optical transmitter, said program code comprising:
a first code segment for causing said processor to cause an optical sensor to sense optical energy proximate a back facet of said optical transmitter;
a second code segment for causing said processor to cause a thermal sensor to sense thermal energy proximate said optical transmitter, wherein:
sensed thermal energy is indicative of a tracking error of said optical transmitter; and
a third code segment for causing said processor to regulate said power of said output optical signal in response to said sensed thermal energy and said sensed optical energy.
